(19) United States
(12) Patent Application Publication
(10) Pub. No.: US 2002/0181190 A1
(43) Pub. Date: Dec. 5, 2002

(54) Laptop with separable touch sensitive display

(76) Inventor: Romulo Monteiro Callado, Boston, MA (US)

Correspondence Address: ROMULO M. CALLADO, 68 DEVON ST. #2, BOSTON, MA, 02121, US

(21) Appl. No.: 09/681,787

(22) Filed: Jun. 5, 2001

(51) Int. Cl. G06F 1/16

(52) U.S. Cl. 361/683; 361/681; 361/680

(57) ABSTRACT

This patent is a technologic nature feature in the computer development field. The idea of separating the screen of the laptop from its main processor part and connect a cable between them is the new concept of this invention.

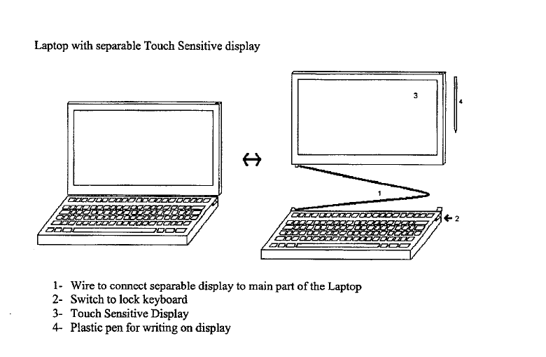

### DETAILED DESCRIPTION

This laptop has a touch sensitive display that has the function of a mouse. Its display part (monitor) is separable from the main part (keyboard, processor and etc) of the laptop.

Once the display is separated, the user can connect a cable from the display to the main part, so it will function as it was before. This laptop also has a switch to lock the keyboard so when this is not being used, the user doesn't press the keys by accident. The touch sensitive display also works with a plastic pen that comes with the machine.

1. I claim as my invention the idea of making a touch sensitive laptop screen and make it separable from the main processor/keyboard part of the laptop and make it connectable by a cable.
I also claim as my invention, to build in this laptop a switch to block the use of the keyboard.
